(19) United States
(12) Patent Application Publication
(10) Pub. No.: US 2019/0346074 A1
(43) Pub. Date: Nov. 14, 2019

(54) THERMAL INSULATED ACCORDING EXPANSION JOINT/HOSE

(71) Applicant: Thermal Structures, Inc., Corona, CA (US)

(72) Inventor: Hector Garcia, Perris, CA (US)

(21) Appl. No.: 16/408,386

(22) Filed: May 9, 2019

Related U.S. Application Data
(60) Provisional application No. 62/669,174, filed on May 9, 2018.

(51) Int. Cl. F16L 11/11; F16L 59/153

(52) U.S. Cl. CPC F16L 11/11; F16L 59/153

(57) ABSTRACT

An accordion-type joint/hose has an undulating flexible wall with an insulation layer sandwiched between inner and outer layers. The undulating flexible wall has a plurality of alternating peaks and valleys that are designed to flex so that the length of the hose can expand and contract. A plurality of substantially parallel expansion regions are disposed inside an interior space of the hose at each peak, such that flexion of the undulating flexible wall at the peaks and valleys causes the expansion regions to expand and contract. A wire mesh binder is sewed into the undulating flexible wall at the peaks and valleys to provide structural rigidity and to prevent insulation material from shifting along the length of the hose during expansion and contraction.

### FIELD OF THE INVENTION

The field of the invention is thermally insulated hoses.

### BACKGROUND

The background description includes information that may be useful in understanding the present invention. It is not an admission that any of the information provided herein is prior art or relevant to the presently claimed invention, or that any publication specifically or implicitly referenced is prior art.

Flexible pipes are often used for drainage, air ducting, combustion exhaust, and the transportation of other fluids. A typical manufacturing process, known as “cording”, involves a coated wire coil, where the tube material is disposed either within or about the wire coil structure. For example, U.S. Pat. No. 6,216,742 to Masui describes the manufacturing process of a heat insulating hose involving curing the tube material on the helical wire structure and then removing the wire, such that the end product retains the shape of a helical wire structure to form corrugated rubber tubing.

Masui also describes the process of treating the wire structure itself as a helical reinforcing component, where the wire structure is placed adjacent to and in axial alignment with the length of the now corrugated rubber tubing. While the teachings of Masui may improve the maneuverability of the pipe at installation, it still suffers limitations in the form of structural fatigue and possible pipe failure caused by the expansion and contraction of the helical structure.

U.S. Pat. No. 7,192,063 to Takagi further attempts to improve flexible pipe technology with a multilayered tube structure, where the innermost tube comprises a corrugated bellows portion. The corrugated bellows comprise peaks and valleys of flexible material. However, the teachings of Takagi appear to suffer similar problems as the teachings of Masui in that the length of a section of a coil-type accordion pipes cannot be readily expanded more than about 50%.

All publications cited herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for an insulated expansion joint/hose where lengthening and shortening is not accomplished by a coated wire coil and is resistant to repeated structural stresses.

### SUMMARY OF THE INVENTION

The inventive subject matter provides apparatus, systems and methods in which an accordion-type joint/hose has an undulating flexible wall with an insulation layer sandwiched between inner and outer layers. The undulating flexible wall has a plurality of alternating peaks and valleys that are designed to flex so that the length of the hose can expand and contract. A plurality of substantially parallel expansion regions are disposed inside an interior space of the hose at each peak, such that flexion of the undulating flexible wall at the peaks and valleys causes the expansion regions to expand and contract. A plurality of static regions are also disposed inside the interior space of the hose at each valley and between expansion regions. As used herein, “static region” means a region that expands and contracts significantly less than the expansion regions when the flexion regions in the undulating flexible wall are flexed.

In some embodiments, the insulation layer can comprise a fibrous material, such as wool. In other aspects of some embodiments, the inner and outer layers can comprise a thin skin made of flexible or elastic material, such as polytetrafluoroethylene. It is further contemplated that the thickness of the insulation layer can be at least 0.25 inches, at least 0.5 inches, or even greater depending on the application. In some embodiments, the thickness of the insulation layer is at least 75% greater than the thickness of the inner and outer layers, more preferably at least 90% greater, most preferably at least 95% greater.

The accordion-type joint/hose can further comprise a wire mesh disposed around the hose at the flexion regions of the undulating wall to provide additional structural support. It is further contemplated that the wire mesh can be disposed inside the undulating wall and configured as baffles that prevent the material in the insulation layer from shifting along the length of the hose. The wire mesh can be fastened together and secured to the hose using sewing thread.

In some applications, it is contemplated that the accordion-type joint/hose can be used in an air duct insulated system for transferring cool air from 100 Deg. Fahrenheit up to 550 Deg. Fahrenheit. It is also contemplated that the hose can be used to transfer hot air thru an ambient environment temperature that is well above or below the temperature of the air inside the hose.

In yet other aspects, accordion-type joint/hose can expand up to 3× in length, with a recommended expansion of 2×. In addition, it is contemplated that hoses according to the inventive concepts herein can be produced in custom lengths from 1 ft. up to 50 ft. or more.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an exemplary pipe structure in an expanded configuration.

FIG. 2 illustrates the pipe structure of FIG. 1 in a contracted configuration.

FIG. 3 illustrates a cross-sectional view of the pipe structure of FIG. 1 along line A-A.

FIG. 4 illustrates a close-up view of Peak B of the pipe structure of FIG. 3.

FIG. 5 illustrates a close-up view of Valley C of the pipe structure of FIG. 3.

FIG. 6 illustrates a cross sectional view of the pipe structure of FIG. 4 along line D-D showing a wire mesh binder and sewing thread.

### DETAILED DESCRIPTION

One should appreciate that the hoses, joints, and pipe structures described herein provide many advantageous technical effects such as thermally insulated flexible hoses that can expand and contract along its length.

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

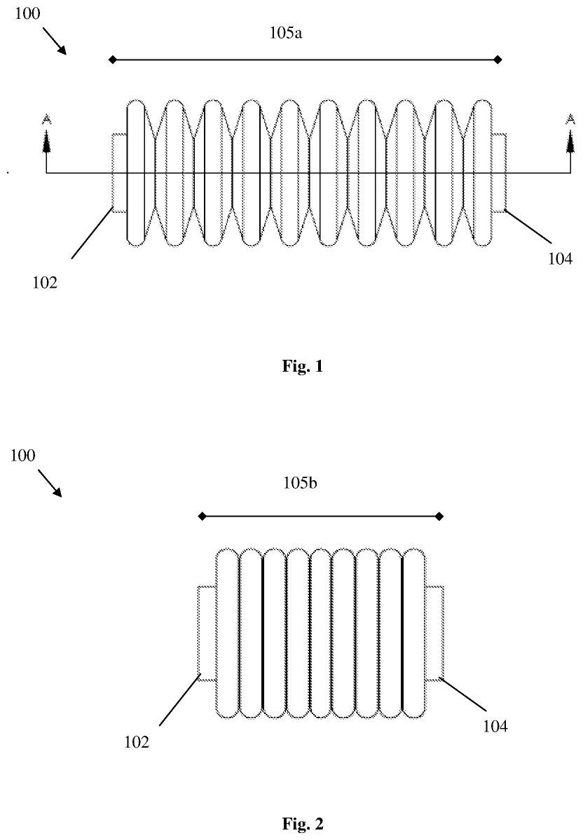

FIG. 1 illustrates an pipe structure 100 (e.g., an accordion-type joint/hose) according to some embodiments of the inventive subject matter. In this example, the pipe structure 100 is in its expanded configuration with a length 105a. Length 105a is preferably equal to 1 foot long. Pipe structure 100 also includes two ports 102 and 104. A port can be an inlet or an outlet. In a preferred embodiment, port 102 is an inlet and port 104 is an outlet.

FIG. 2 illustrates the pipe structure 100 according to some embodiments of the inventive subject matter. In this example, the pipe structure 100 is in its contracted configuration with a length 105b. Length 105b is preferably equal to 0.3 foot long. Pipe structure 100 also includes two ports 102 and 104. A port can be an inlet or an outlet. In a preferred embodiment, port 102 is an inlet and port 104 is an outlet.

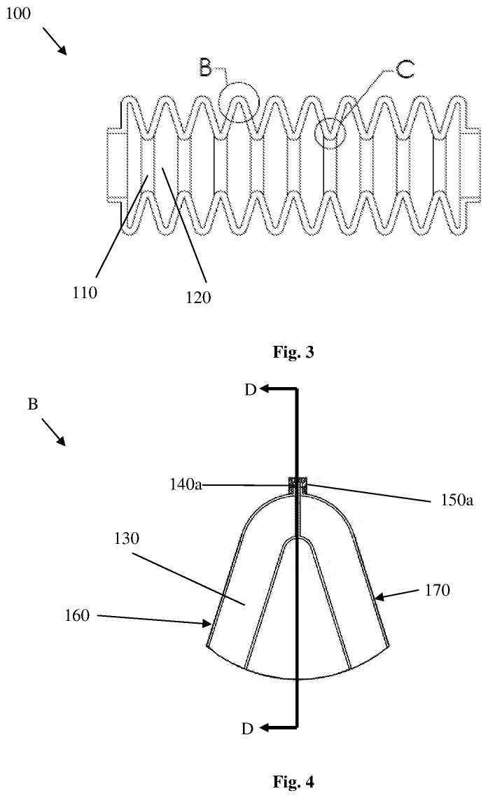

FIG. 3 illustrates the pipe structure 100 in a cross-sectional view along line A-A of FIG. 1 in an expanded configuration. In this example, the pipe structure 100 includes expansion region 120, static region 110, peak B and valley C. In preferred embodiments, expansion region 120 expands when force is applied in opposing directions relative to the center of the pipe structure 100. In other embodiments, expansion region 120 expands when the internal pressure of pipe structure 100 is equal or greater than the external pressure acting on pipe structure 100. Static region 110 is capable of expanding along with expansion region 120. However, static region 110 does not expand to the same degree as expansion region 120. Preferably, static region may expand to only 10% of the expansion of expansion region 120. Even more preferably, static region may expand to only 1% of the expansion of expansion region 120.

In preferred embodiments, the length of the hose is expanded by increasing the acute angles of the peaks and valleys, thereby expanding the expansion regions, rather than by lengthening a continuous spiraling coil in the hose, such as is taught in Matsui. Moreover, the length of the hose is contracted by decreasing the acute angle of the peaks and valleys, thereby contracting the expansion regions.

FIG. 4 illustrates a close-up of Peak B of the pipe structure 100 as shown in FIG. 3. The close-up cross sectional view shows a wire mesh binder 150 disposed between two donut-shaped sections of the hose 160 and 170. The donut-shaped sections 160 and 170 are joined together by sewing thread 150a through the wire mesh binder 140a along the outer and inner layers of each section.

FIG. 5 illustrates a close-up of Valley C of the pipe structure of 100 as shown in FIG. 3. Valley C has a similar construction as Peak B and comprises two donut-shaped sections of the hose 165 and 175, with a wire mesh binder 140b disposed between the sections, and sewing thread 150b for joining the sections.

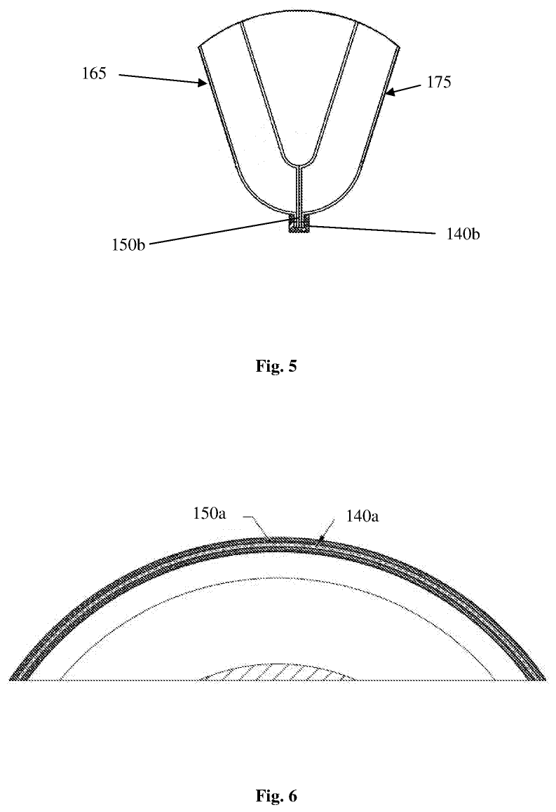

FIG. 6 illustrates a cross-sectional view of the Peak B of FIG. 3 along line D-D. From this perspective, wire mesh binder 150a is disposed between the donut-shaped sections 160 and 170, and disposed throughout the insulation layer 130 of the undulating flexible wall. The wire mesh binder 150a provides structural rigidity to the pipe structure 100 during expansion and contraction, and also helps to prevent insulation material in the insulation layer from shifting along the length of the pipe structure 100.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

What is claimed is:

1. An accordion-type hose comprising:
an undulating flexible wall having a plurality of peaks and a plurality of valleys;
a plurality of substantially parallel expansion regions disposed inside an interior space of the hose;
wherein the undulating flexible wall comprises an insulation layer disposed between an inner layer and an outer layer; and
wherein expansion and contraction of the expansion regions along a length of the hose is accomplished by flexion of the peaks and valleys rather than lengthening of a coil.

2. The hose of claim 1, wherein the insulation layer comprise a fibrous material.

3. The hose of claim 1, wherein the insulation layer comprise a wool.

4. The hose of claim 1, wherein at least one of the inner and outer layers comprises a polytetrafluoroethylene (PTFE).

5. The hose of claim 1, further comprising a wire mesh binder at the flexion regions.

6. The hose of claim 1, wherein the insulation layer is at least 0.25 inches thick.

7. The hose of claim 1, wherein the insulation layer is at least 0.5 inches thick.

8. The hose of claim 1, further comprising a sewing thread for joining the wire mesh binder of adjacent sections of the undulating flexible wall together.

9. The hose of claim 1, further comprising a plurality of substantially parallel non-expansion regions disposed between the expansion regions.

10. The hose of claim 9, wherein the expansion regions are disposed along the length of the hose at each peak.

11. The hose of claim 10, wherein the non-expansion regions are disposed along the length of the hose at each valley.

12. The hose of claim 1, wherein the thickness of the insulation layer is at least 75% greater than a thickness of the inner and outer layers.
